(19) United States
(12) Patent Application Publication
(10) Pub. No.: US 2005/0077811 A1
(43) Pub. Date: Apr. 14, 2005

(54) Field emission device and method of fabricating same

(76) Inventors: Zhuo Sun, Shanghai (CN); Beng Kang Tay, Singapore (SG); Shu Ping Lau, Singapore (SG); Yunjun Li, Austin, TX (US)

Correspondence Address: Ralph A. Dowell of DOWELL & DOWELL P.C., 2111 Eisenhower Ave., Suite 406, Alexandria, VA, 22314, US

(21) Appl. No.: 10/496,675

(22) PCT Filed: Nov. 26, 2002
(86) PCT No.: PCT/SG02/00274

(30) Foreign Application Priority Data
Nov. 27, 2001 (SG) 200107438-4

(51) Int. Cl. H01J 1/62; H01J 63/04

(52) U.S. Cl. 313/495

(57) ABSTRACT

This invention relates to a method of fabricating a field emission device (FED) by using a carbon composite film, the composite film providing a field emission layer which consists of fine carbon-metal grains and/or carbon nanotubes, so that (a) a threshold voltage required for emitting electrons from the field emission device can be lowered significantly; (b) a stable electron beam of the field emission display device can be increased; and, (c) emission Uniformity and emission spot density can be greatly improved. The fabrication method involves preparing a metal-carbon composite film on a suitable substrate using an appropriate deposition technique. The carbon composite film is then thermally treated post-deposition, so as to form nano-particles and/or nanotubes in the film. Post-treatment of the composite film may involve annealing or plasma etching using hydrogen or hydrocarbon gas to reduce the electron emission barrier. During deposition of the metal-carbon composite film, the composition of the metal content in the film can be tuned to control the field emission properties of the field emission component.

### FIELD OF THE INVENTION

The present invention relates to a field emission device (FED) and method of fabricating same and relates particularly, though not exclusively, to a method of fabricating a field emission component for use in flat panel displays and vacuum microelectronics applications.

### BACKGROUND TO THE INVENTION

A field emission cathode has been used in flat panel displays and vacuum microelectronics applications. Cold cathode and field emission based flat panel displays have several advantages over other types of flat panel displays. These include low power dissipation, high intensity and low projected cost. Conventionally, to fabricate a sub-micron stiff silicon or molybdenum tips, a complicated micro-fabrication technique for preparation of three dimensional structures by a repeated process of depositing and etching has been used. Present small FED cathodes use arrays of microtips with gate apertures of about 1 μm in diameter. These are made in a semiconductor type fabrication facility. A number of companies now offer 5- to 6- in monochrome FEDs in sample quantities based on this approach. Although they produce high-quality displays, system costs are high and production yields are very poor. This is because they are working at the limits of photofabrication with slow and expensive step and repeat exposures. It is very difficult to scale up this approach to large area displays.

In view of the fabrication complexities and cost, research continues into planar emitters, especially using carbon-based materials as emitters. Those being explored are cathodes using a thin film of diamonds, diamond-like carbon and carbon nanotubes (CNTs) as the emitters. The structure of the devices and the fabrication process for these carbon-based emitters is much more simple. However, high temperature deposition with low growth rate and small area for the diamond film, limits diamond films for practical application. Although diamond-like carbon films can be deposited with a high rate at low temperature over a large area, the field emission properties are poor. For diamond films prepared by chemical vapour deposition (CVD), or diamond-like carbon (DLC) films deposited by plasma enhanced (PE) CVD, filtered cathodic vacuum arc (FCVA) deposition, pulsed laser ablation (PLA), ion beam deposition (IBD) or magnetron sputtering (MS), the electron emission threshold field is normally high (above 20 V/μm), and emission spot density is low (below 10³/cm²). Conditioning phenomena (pretreating the film surface by using a high voltage) exists in the emission process for diamond and DLC films, which occurs randomly and is difficult to control.

CNT material is an interesting material for electron FE applications and shows the best FE properties, as the graphitic nanotubes possess a good conductivity, and the emission local field enhancement is high due to the high aspect ratios. Some low-resolution prototype FEDs using screen-printing have been reported. For high-resolution displays, growth of a thin CNT film on a substrate is required. However, controllability of CNT film is difficult and the adhesion between CNT film and substrate is poor by using normal chemical vapour deposition method. Furthermore, the growth temperature of CNT film is normally high (700-1200° C.).

### SUMMARY OF THE INVENTION

The present invention was developed with a view to providing a field emission component for a field emission device with a relatively large and thermally stable emission area, and a simple method of fabricating same.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

According to one aspect of the present invention there is provided a method of fabricating a field emission component for a field emission device (FED), the method comprising the steps of:

preparing a metal-carbon composite film on a suitable substrate using an appropriate deposition technique;

thermally treating the carbon composite film post-deposition so as to form nano-particles and/or nanotubes in the film;

whereby, in use, a field emission component with relatively large surface area and improved emission spot density can be fabricated.

Preferably said step of thermally treating the film involves annealing or plasma etching using hydrogen or hydrocarbon gas to reduce the electron emission barrier. Typically said hydrogen or hydrocarbon gas is supplied at a pressure below one atmosphere and the annealing temperature is between 25° C. and 1200° C., more preferably between 400° C. and 1200° C. When a glass substrate is employed, thermal treatment at a temperature below 700° C. is preferred.

Typically said deposition technique is selected from the group comprising Chemical Vapour Deposition (CVD), Plasma Enhanced (PE) CVD, Physical Vapour Deposition (PVD), Filtered Cathodic Vacuum Arc (FCVA) Deposition, Pulsed Laser Ablation (PLA), Ion Beam Deposition (IBD) or Magnetron Sputtering (MS). Preferably, during deposition of said metal-carbon composite film, some metal elements are incorporated into the film. Typically the metal elements are selected from the group comprising Fe, Co, Ni, Pt, Pd, Ir, Mo, Ti, Cr, W, Ta, Al, etc. Advantageously, during deposition of said metal-carbon composite film, the composition of the metal content in the film can be tuned to control the field emission properties of the field emission component.

Preferably, when using an insulating substrate, a conductive metal layer is deposited first before the metal-carbon composite film is deposited. However, when using a conductive substrate, the metal-carbon composite film may be deposited directly onto the substrate.

Typically said metal-carbon composite film comprises a diamond film or a diamond-like carbon (DLC) film.

According to another aspect of the present invention there is provided a field emission component for a field emission device (FED), the component comprising:

a metal-carbon composite film deposited on a suitable substrate, said film having been thermally treated post-deposition to form nano-particles and/or nanotubes therein whereby, in use, said field emission component has a relatively large surface area and improved emission spot density.

Preferably said metal-carbon composite film is provided with a hydrogenated carbon surface as a result of said thermal treatment.

Preferably said metal-carbon composite film has some metal elements incorporated into the film during deposition. Typically the metal elements are selected from the group comprising Fe, Co, Ni, Pt, Pd, Ir, Mo, Ti, Cr, W, Ta, Al, etc.

Typically said field emission component is a cold cathode in a field emission display device.

### BRIEF DESCRIPTION OF DRAWINGS

In order to facilitate a better understanding of the nature of the invention, preferred embodiments of the field emission device and method of fabricating same will now be described in greater detail, by way of example only, with reference to the accompanying drawings, in which:

FIGS. 1A-D show cross-section schematics of the method of fabricating a field emitter on an insulator substrate in accordance with one embodiment of the present invention;

FIGS. 2A-C show cross-section schematics of the method of fabricating a field emitter on a conductive substrate in accordance with an embodiment of the present invention;

FIGS. 3A-B illustrate schematically a triode-type field emission device (on insulating and conductive substrates respectively) in accordance with an embodiment of the present invention;

FIG. 4 illustrates graphically the characteristics of emission turn-on field and current density for various carbon films (1-DLC; 2-MCC; 3-DLC, hydrocarbon anneal; 4-MCC, hydrogen anneal; 5-MCC, hydrocarbon anneal);

FIGS. 5 illustrates graphically the emission spot densities for various carbon films (1-DLC; 2-MCC; 3-DLC, hydrocarbon anneal; 4-MCC, hydrogen anneal; 5-MCC, hydrocarbon anneal);

FIG. 6 shows an example of the characteristic of emission current density dependence on applied field and an image of the spatial distribution of the emission spots on the ITO-glass anode for a metal-carbon composite film, in accordance with an embodiment of this invention; and,

FIGS. 7(a) and (b) illustrate examples of field emission diode-structure displays. (a) A star image display on ZnO:Zn phosphor coated ITO plate (at 10 V/μm); (b) Lines image display on ITO plate (at 12 V/μm).

### DETAILED DESCRIPTION OF PREFERRED EMBODIMENTS

The present invention utilises the extraordinary properties of metal-carbon composite materials to provide a thermally stable emission area for a field emission device (FED). A preferred embodiment of a field emission device and method of fabricating same will now be described with reference to the accompanying drawings.

The fabrication method typically involves deposition of a metal-carbon composite film at low temperature and large area, increasing the conductivity of the carbon film by adding a metal element, and forming carbon nano-particles and a hydrogenated carbon surface by post-treatment, such as hydrocarbon gas or hydrogen annealing or plasma treatment, to reduce the electron emission barrier. For Fe, Co, Ni, Pt, Pd, Ir containing carbon composite films, the thermal treatment is preferably applied between 25° C. and 1200° C. in a hydrocarbon gas to form carbon nano-particles and/or nanotubes in the composite films, thus enhancing the conductivity and emission spot density significantly. For a glass substrate, post-treatment at low temperature (below 700° C.) is preferred.

The carbon nano-particles or nanotube films produced by this process can be used as a cold cathode material which possesses good electron field emission properties, i.e., lower threshold field (below 5 V/μm), high emission current density (above 10 mA/cm²) and emission spot density (above 10⁴/cm²). The process is also simple for field emission device fabrication.

Diamond or DLC films are interesting materials that are suitable for use as a cathode for electron field emission devices, because of their high thermal conductivity, high chemical stability and low electron affinity to electron field emission of the diamond surface. However, the high resistivity of diamond or DLC limits the emitted current thus limiting its practical application. For polycrystalline diamond films prepared by chemical vapour deposition (CVD), or DLC films deposited by plasma enhanced (PE) CVD, physical vapour deposition (PVD), such as filtered cathodic vacuum arc (FCVA) deposition, pulsed laser ablation (PLA), ion beam deposition (IBD) or magnetron sputtering (MS), the electron field emission voltage is normally high (above 20 V/μm) and emission spot density is low (below 10³/cm ²). As noted above, a conditioning phenomena exists in the emission process for diamond or DLC films, which occurs randomly and is difficult to control. For practical application, DLC film is preferred due to its low temperature (below 200° C.) deposition with large area, as compared to with diamond film which is deposited at relatively higher temperature (above 600° C.) and smaller area

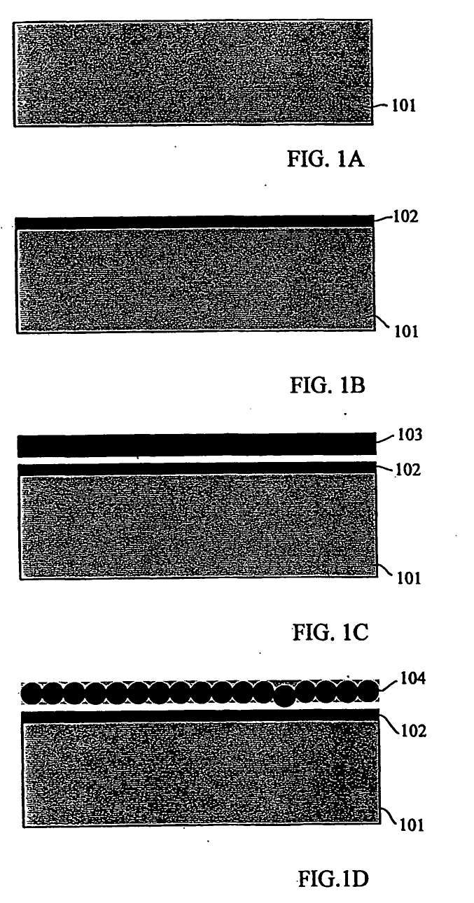

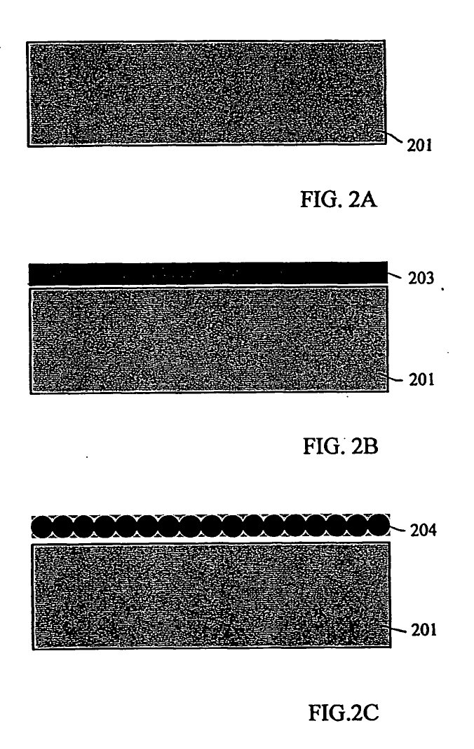

In the preferred fabrication method of the invention, metal (Fe, Co, Ni, Pt, Pd, Ir, Mo, Ti, Cr, W, Ta, Al, etc.) containing carbon composite films were prepared at low temperature by using one of the above deposition methods, then post-treated by hydrocarbon gas or hydrogen annealing or plasma etching to form nano-particles/tubes in the films. The fabrication steps are shown schematically in FIG. 1a-d and FIG. 2a-c for insulating and conductive substrates, respectively. For an insulating substrate 101, such as glass, ceramic, a conductive metal layer 102 needs to be deposited of first using PVD/CVD (sputtering, etc.) before deposition of the metal-carbon composite film 103 or 203 (FIGS. 1b and c). For a conductive substrate 201, the metal-carbon composite film can be deposited on the substrate directly (FIG. 2b).

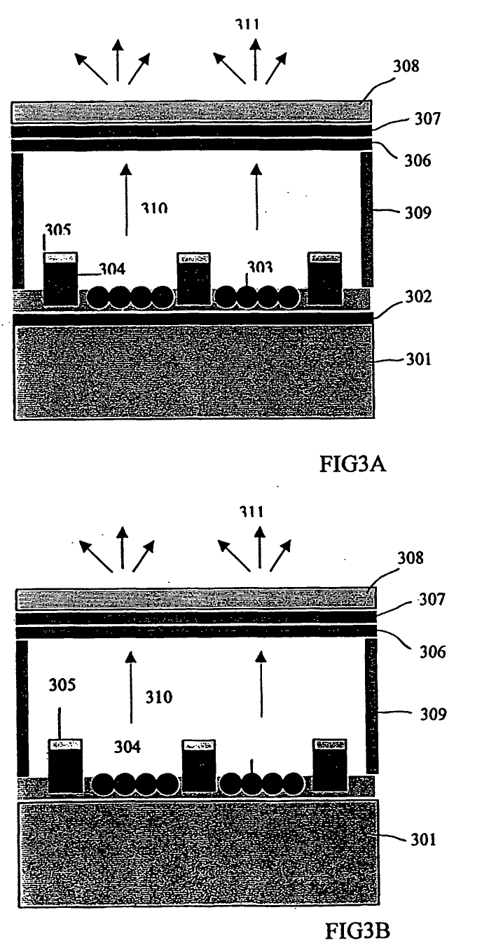

An illustrative embodiment of a triode-type field emission display device made in accordance with the invention is shown in FIG. 3. FIG. 3a illustrates an FED with field emission cathode formed on an insulating substrate 301, whereas FIG. 3b illustrates an FED with a field emission cathode formed on a conductive substrate 301a. The cathode consists of substrate 301, conductive layer 302, and a metal-carbon composite layer 303. The gate consists of a dielectric layer 304 such as SiO₂, Si₃N₄, and a metal layer 305. The anode consists of a layer of phosphor 306 coated with indium tin oxide (ITO) 307—on a glass substrate 308. The cathode and anode can be separated by using an insulating spacer 309. During normal operation, electron emission 310 from the cathode 300 can be controlled by a low voltage applied to the gate. The light 311 can be emitted from a phosphor coated ITO-glass anode.

During metal-carbon composite film deposition, some metal elements, such as Fe, Co, Ni, Pt, Pd, Ir, Mo, Ti, Cr, W, Ta, Al, etc., can be incorporated into the DLC films. For hydrogen free DLC film, the metal-carbon composite films can be prepared by FCVA, PLA, IBD and MS using metal-graphite composite targets. The ratio of the metal/graphite of the targets is in the range of 1-50% (atm.). For hydrogenated DLC film, MC film can be prepared by PECVD using a metal-containing hydrocarbon precursor. The thickness of the metal-carbon composite film is below 500 nm.

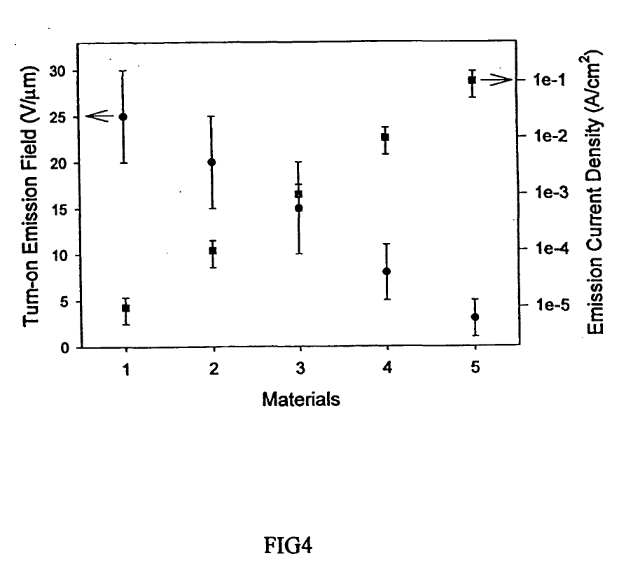

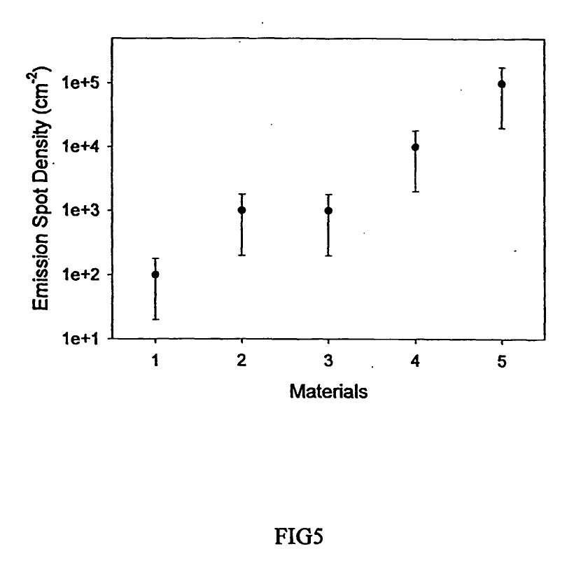

The field emission properties of metal-carbon composite (MCC) films can be improved comparing to the DLC films, as shown in FIG. 4 and FIG. 5, respectively. (1-DLC; 2-MCC; 3-DLC, hydrocarbon anneal; 4-MCC, hydrogen anneal; 5-MCC, hydrocarbon anneal). As can be seen from FIG. 4, the turn on emission (threshold) field progressively decreases from a high of 25V/μm for a normal DLC film, to a value of 5V/μm for a hydrocarbon annealed MCC film. Similarly, the emission current density progressively increases from a low value of less than 10⁻⁵A/cm² for a normal DLC film, to a high value of 10⁻¹A/cm² for a hydrocarbon annealed MCC film. FIG. 5 illustrates how the emission spot density also progressively increases from a low value of 10²/cm² for a normal DLC film to a high value of 10⁵/cm² for a hydrocarbon annealed MCC film.

For practical application, lower threshold field, higher emission current density and emission spot density are desired. To enhance these field emission properties, post-treatments, such as annealing or plasma/ion-beam treatments, to the metal-carbon composite films are needed. During the post-treatment process, some carbon and/or metal nano-particles (below 500 nm in size) or nano-tubes 104 and 204 can form in the amorphous carbon matrix (FIG. 1d and FIG. 2c), which is beneficial to increasing the conductivity of the composite films. The preferred post-treatment in this invention is anneal or plasma treatment using hydrogen or hydrocarbon gas diluted in hydrogen (nitrogen, argon, etc.) below one atmospheric pressure, with an annealing temperature between 25° C. and 1200° C., and more preferably between 400° C. and 1200° C. For Co, Fe, Ni, Pt, contain carbon films, it is possible to form carbon nanotubes in the film during annealing in hydrocarbon gas. By controlling the composition of the metal (Fe, Co, Ni, Pt, Pd, Ir) content in the carbon film, the carbon nanotube density can be controlled. In this way, the film structures can be optimized for good field emission properties, and the film possesses smooth surface, and good adhesion (stability) to the substrate.

After post-treatment, the surface of the film may be terminated by hydrogen (C—H bonds), which may reduce the average emission barrier and enhance the emission. The relative amounts of metal, sp³/sp² carbon phases in the carbon composite film would allow some control over the work function, electrical conductivity, and electron field emission characteristics of the composite film. The composite carbon film thus formed would be an efficient electron emitter since this structure optimizes conductivity and surface work function for electron emission. The metal and/or graphitic matrix provides a means of transporting electrons to the carbon surface, and exits from the hydrogenated carbon surface. Thus the threshold emission field decreases, while the emission current density and emission spot density increases greatly, as shown in FIG. 4 and FIG. 5.

The invention will be further described with reference to the following non-limiting examples of experimental field emission components fabricated in accordance with the present invention.

### EXAMPLE 1

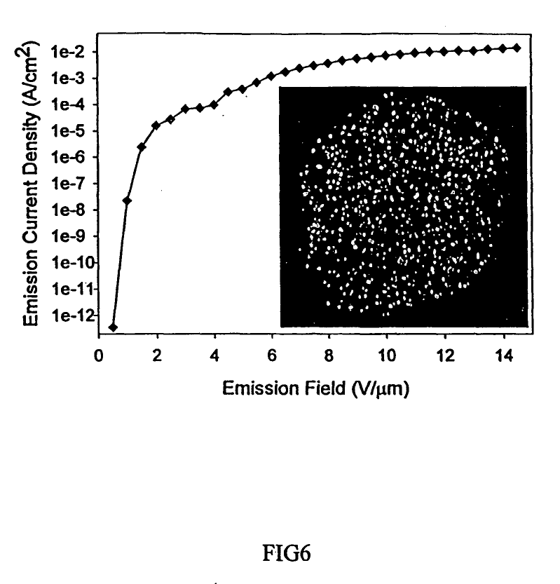

The emission current density dependence on the applied field for a FeC composite film prepared by using this invention is shown in FIG. 6. An image of the spatial emission spots on the ITO-glass anode is inserted in the drawing. The emission area is 6 mm in diameter. Clearly, the FeC film shows a very good emission property, i.e., high emission current density (10 mA/cm² at 10 V/μm), low turn-on emission field (1 V/μm at 1 nA/cm²), high emission spot density (10⁴/cm²), and a uniform distribution of spatial emission spots.

### EXAMPLE 2

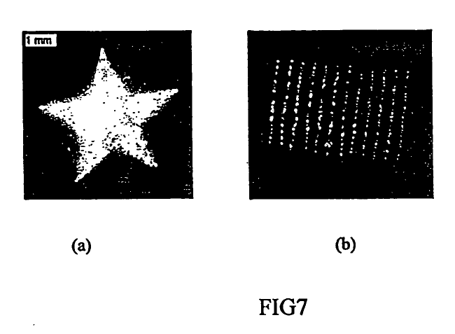

FIGS. 7(a) and (b) show examples of diode-type field emission displays using a carbon composite film as emitter. A star image about 5 mm in size on a ZnO:Zn phosphor coated ITO plate can been seen in FIG. 7(a), with an applied field of 10 V/μm. A uniform emission image with high emission spots has been obtained at such low field. FIG. 7(b) shows a line image of field emission array on ITO plate. The line width is 100 μm, the applied field is 12 V/μm. Twelve pieces of luminance lines of 10 mm in length can be clearly seen. From this result, it is apparent that a high-resolution field emission display can be achieved using the invented carbon composite films as emitters.

Now that preferred embodiments of the field emission component for a field emission device (FED) and method of fabricating same have been described in detail, it will be apparent that they provide a number of significant advantages over comparable prior art techniques, including, but not limited, to the following:

(a) It provides a low temperature process for fabricating cold cathode field emission emitters;

(b) It facilitates fabrication of a relatively large surface area field emitter;

(c) High deposition rates can be achieved;

(d) It can produce a field emitter which requires only a small turn on voltage for field emission to occur;

(e) Inexpensive substrates can be employed in the fabrication process;

(f) By changing the composition of the metal in the composite film, the field emission properties can be tuned during device fabrication; and

(g) A stable and uniform field emission display device can be fabricated.

Numerous variations and modifications may suggest themselves to persons skilled in the microelectronics fabrication arts, in addition to those already described, without departing from the basic inventive concepts. All such variations and modifications are to be considered within the scope of the present invention, the nature of which is to be determined from the foregoing description and the appended claims.

1. A method of fabricating a field emission component for a field emission device (FED), the method comprising the steps of:
preparing a metal-carbon composite film on a suitable substrate using an appropriate deposition technique; and
thermally treating the metal-carbon composite film post-deposition so as to form nano-particles and/or nanotubes in the film;
whereby, in use, a field emission component with relatively large surface area and improved emission spot density can be fabricated.

2. A method of fabricating a field emission component as defined in claim 1, wherein during deposition of said metal-carbon composite film, some metal elements are incorporated into the film.

3. A method of fabricating a field emission component as defined in claim 2, wherein the metal elements are selected from the group comprising Fe, Co, Ni, Pt, Pd, Ir, Mo, Ti, Cr, W, Ta, Al, etc.

4. A method of fabricating a field emission component as defined in claim 2, wherein during deposition of said metal-carbon composite film, the composition of the metal content in the film can be tuned to control the field emission properties of the field emission component.

5. A method of fabricating a field emission component as defined in claim 1, wherein the thickness of the metal-carbon composite film is less than 500 nm.

6. A method of fabricating a field emission component as defined in claim 1, wherein said deposition technique is selected from the group comprising Chemical Vapour Deposition (CVD), Plasma Enhanced (PE) CVD, Physical Vapour Deposition (PVD), Filtered Cathodic Vacuum Arc (FCVA) Deposition, Pulsed Laser Ablation (PLA), Ion Beam Deposition (IBD) or Magnetron Sputtering (MS).

7. A method of fabricating a field emission component as defined in claim 1, wherein said step of thermally treating the film involves annealing or plasma etching using hydrogen or hydrocarbon gas to reduce the electron emission barrier.

8. A method of fabricating a field emission component as defined in claim 7, wherein said hydrogen or hydrocarbon gas is supplied at a pressure below one atmosphere and the annealing temperature is between 25° C. and 1200° C.

9. A method of fabricating a field emission component as defined in claim 7, wherein the annealing temperature is between 400° C. and 1200° C.

10. A method of fabricating a field emission component as defined in claim 9, wherein when a glass substrate is employed, the thermal treatment is performed at a temperature below 700° C.

11. A method of fabricating a field emission component as defined in claim 1, wherein when using an insulating substrate, a conductive metal layer is deposited first before the metal-carbon composite film is deposited.

12. A method of fabricating a field emission component as defined in claim 1, wherein when using a conductive substrate, the metal-carbon composite film may be deposited directly onto the substrate.

13. A method of fabricating a field emission component as defined in claim 1, wherein said metal-carbon composite film comprises a diamond film or a diamond-like carbon (DLC) film.

14. A field emission component for a field emission device (FED), the component comprising:
a metal-carbon composite film deposited on a suitable substrate, said film having been thermally treated post-deposition to form nano-particles and/or nanotubes therein whereby, in use, said field emission component has a relatively large surface area and improved emission spot density.

15. A field emission component as defined in claim 13, wherein said metal-carbon composite film is provided with a hydrogenated carbon surface as a result of said thermal treatment.

16. A field emission component as defined in claim 13, wherein said metal-carbon composite film has some metal elements incorporated into the film during deposition.

17. A field emission component as defined in claim 15, wherein the metal elements are selected from the group comprising Fe, Co, Ni, Pt, Pd, Ir, Mo, Ti, Cr, W, Ta, Al, etc.

18. A field emission component as defined in claim 13, wherein said field emission component is a cold cathode for field emission applications including display devices, pressure sensors, x-ray tubes and other vacuum microelectronics applications.
